(19) United States
(12) Patent Application Publication
(10) Pub. No.: US 2010/0000864 A1
(43) Pub. Date: Jan. 7, 2010

(54) GAS SENSOR WITH PUMP CELL AND ADDITIONAL OUTER ELECTRODE

(76) Inventors: Lothar Diehl, Gerlingen (DE); Thomas Seiler, Stuttgart (DE)

Correspondence Address: MERCHANT & GOULD PC, P.O. BOX 2903, MINNEAPOLIS, MN, 55402-0903, US

(21) Appl. No.: 12/282,114

(22) PCT Filed: Feb. 9, 2007
(86) PCT No.: PCT/EP07/51266

§ 371 Date: Nov. 25, 2008

(30) Foreign Application Priority Data
Mar. 13, 2006 (DE) 102006011480.9

(51) Int. Cl. G01N 27/419

(52) U.S. Cl. 204/425

(57) ABSTRACT

The invention relates to a gas sensor, especially a lambda probe, for determining the oxygen concentration in the exhaust gas of an internal combustion engine that is operated with a fuel/air mixture. Said gas sensor comprises a pump cell arranged in or on a sensor element, said pump cell having a first electrode and a second electrode that are separated from the exhaust gas by at least one layer, and an electronic circuit for producing a voltage applied between the first electrode and the second electrode and for measuring and evaluating a pump current thereby produced in order to make it possible to draw conclusions therefrom on the composition of the fuel/air mixture. The invention is characterized in that an additional outer electrode is arranged on the sensor element. Said additional electrode is exposed to the exhaust gas and supplied with a negative current.

### TECHNICAL FIELD

The invention concerns a gas sensor according to claim 1.

### BACKGROUND

Electrochemical gas sensors in the form of lambda sensors are used in vast numbers in exhaust gas systems of combustion engines in motor vehicles, in order to be able to provide signals about the exhaust gas composition for the engine control. Hereby the engine can be operated in such a way that the exhaust gases provide an optimal composition for the after-treatment with catalyzers that are usually present in the exhaust gas system nowadays.

FIG. 1 shows a generic gas sensor that is known from the state of the art. The sensor element 100 provides a gas entry hole 115, through which exhaust gas flows in and gets through a diffusion barrier 120 in a measuring space 130. A first electrode, also termed outer electrode or outer pump electrode 150, is arranged at the outside of the solid electrolyte 110 and under a porous protection coating 155 and exposed to the exhaust gas of a (not shown) combustion engine. A second electrode, also termed inner electrode or inner pump electrode 140, is arranged in the measuring space.

Between the inner pump electrode 140 and the outer pump electrode 150 a pump voltage Uₚᵤₘₚ is applied, so that a pump current Iₚᵤₘₚ flows. Furthermore a heater 160 that is embedded in an isolation coating 162 is arranged in the solid electrolyte 110. By this heater 160 the sensor element is heated to a temperature which allows an optimal functioning of the sensor element 100.

This planar wide band lambda sensor is impinged with a solid pump voltage Uₚᵤₘₚ according to the limiting current principle. At a lean exhaust gas, which means at an exhaust gas with excess air, the solid pump voltage produces a positive pump current Iₚᵤₘₚ, which is clearly connected with the oxygen content of the exhaust gas. However at a rich exhaust gas, which means exhaust gas with excess fuel, it also comes to a positive pump current due to the decomposition of the water that is contained in the exhaust gas at the inner pump electrode 140. The applied pump voltage Uₚᵤₘₚ admittedly lies clearly below the decomposition voltage of the water, but since hydrogen exists in the exhaust gas the water decomposition becomes energetically possible, because water is produced at the outer electrode 150 from the reaction of the hydrogen with the oxygen ions. The pump current Iₚᵤₘₚ is also limited at a rich exhaust gas by the hydrogen content. Because the pump current Iₚᵤₘₚ in the rich exhaust gas provides the same direction as the pump current Iₚᵤₘₚ at a lean exhaust gas, the exhaust gas composition cannot be implied anymore from the pump current Iₚᵤₘₚ without further ado.

The task of the present invention is to improve a generic gas sensor in such a way that it can be determined whether a lean or a rich exhaust gas is present.

### SUMMARY

This task is accomplished by a gas sensor with the characteristics of claim 1.

Advantageous improvements of the gas sensor are all subject matter of the sub-claims that refer to claim 1.

The basic idea of the invention is to bring oxygen to the second electrode with the aid of an additional outer electrode, which functions as an additional pump electrode in the exhaust gas. This oxygen is additionally pumped out during the operation of the gas sensor, so that by doing so an output signal accrues, which corresponds with a defined lean exhaust gas. If the additional pump current is chosen big enough, even at a rich exhaust gas only a normal positive pump current is reached. Hereby a clear relation between the value of the pump current and the exhaust gas composition from the rich to the lean range is enabled. In comparison to wideband lambda sensors that are known per se and shown in FIG. 1, the pump current has not to pass a change of direction, whereby a faster dynamic is enabled.

In a first advantageous embodiment it is provided that the first electrode is arranged on a solid electrolyte, which is forming the sensor element and which is separated from the exhaust gas by a protective layer, and that the second electrode is arranged in a measuring gas space, which is arranged in the solid electrolyte and also termed as measuring volume and which is separated from the exhaust gas by a diffusion layer or a diffusion barrier. In this embodiment the first electrode can also be termed as the outer electrode and the second electrode as the inner electrode.

In a further advantageous embodiment it is provided that both the first and the second electrode are arranged on the solid electrolyte and both separated from the exhaust gas by a protective layer. In this case the measuring gas space that is arranged in the solid electrolyte can be omitted, which especially simplifies also the production of such a gas sensor essentially.

According to a third advantageous embodiment the first and the second electrode are arranged on the solid electrolyte, but separated from the exhaust gas by separate protective layers.

The additional electrode can basically be arranged at the same side of the sensor element like the first and the second electrode or at its turned away side.

An advantageous embodiment provides that the additional outer electrode is arranged at the sensor element on the side that is turned away from the first electrode. The sensor element preferably creates a solid electrolyte, which is also built in layers and at whose outer surface that is turned away from the first electrode the additional outer electrode is arranged.

To prevent sediments and to reduce the λ=1-waviness the additional outer electrode is furthermore advantageously covered with a protective layer.

In another embodiment on the other hand the additional outer electrode is arranged on the same side as the first and second electrode, whereby it can be separated from the exhaust gas by the same protective layer with which the first and second electrodes are covered as well. Alternatively it can also be covered by a separated protective layer and thereby be separated from the exhaust gas.

Preferably the additional outer electrode is impinged with a constant negative current. Hereby additional oxygen is pumped during the operating of the gas sensor to the second electrode in such a way that a defined too lean output signal of the gas sensor accrues.

In an advantageous embodiment it is provided that the additional outer electrode has its own measurement line, which is connected to the circuit.

In another advantageous embodiment, in which such an additional signal line can be omitted, it is provided that the additional outer electrode is electrically-conductive connected with the mass connection of a heating device.

The circuit is preferably part of an engine control unit, so that additional circuit parts can be omitted.

### BRIEF DESCRIPTION OF THE DRAWINGS

Further advantages and characteristics of the invention are subject matter of the following description as well as of the drawings of embodiments of the invention.

The drawing show in:

FIG. 1 is a gas sensor that is known from the state of the art;

FIG. 2 is an embodiment of a gas sensor according to the invention;

FIG. 3 is another embodiment of a gas sensor according to the invention;

FIG. 4 is a plot of the current over the air value λ in a gas sensor as it is shown in FIG. 1;

FIG. 5 is a plot of the pump current over the air value λ in a gas sensor as it is shown in FIG. 2 or 3;

FIG. 6 is a further embodiment of a gas sensor according to the invention;

FIG. 7 is a further embodiment of a gas sensor according to the invention;

FIG. 8 is a further embodiment of a gas sensor according to the invention; and

FIG. 9 is again another embodiment of a gas sensor according to the invention.

### DETAILED DESCRIPTION

A gas sensor that is already known from the state of the art provides a sensor element 100, which is built by a layered solid electrolyte 110. A first electrode, also termed outer pump electrode 150, which is exposed to the exhaust gas and arranged on the outside of the sensor element 100, is covered by an open-pored protective layer 155. A measuring volume 130, in which the second electrode, also termed inner pump electrode 140, is arranged in the solid electrolyte 110.

The exhaust gas of a (not shown) combustion engine flows through a gas entry hole 115 over a diffusion barrier 120 into the measuring volume 130.

A described electronic circuit 190 produces a constant pump voltage Uₚᵤₘₚ between the pump electrode 150 and the inner pump electrode 140 that is arranged in the measuring volume 130. Hereby a positive pump current Iₚᵤₘₚ adjusts at a lean exhaust gas, which causes that oxygen ions O₂₋ are pumped from the measuring volume 130 into the exterior of the sensor element in the exhaust gas. At a rich exhaust gas composition, which means at a fuel excess of the exhaust gas, it also comes to a positive pimp current due to the decomposition of the water that is contained in the exhaust gas. The applied pump voltage lies hereby clearly under the decomposition voltage of the water. But since hydrogen exists in the exhaust gas the water decomposition is energetically enabled, because water is produced at the outer pump electrode 150 from H₂ and O₂. The current is limited also at a rich exhaust gas composition by the hydrogen content at the outer electrode. Because the pump current Iₚᵤₘₚ shows the same direction at a rich exhaust gas composition as the pump current Iₚᵤₘₚ at a lean exhaust gas composition the exhaust gas composition cannot be implied without further ado from the pump current.

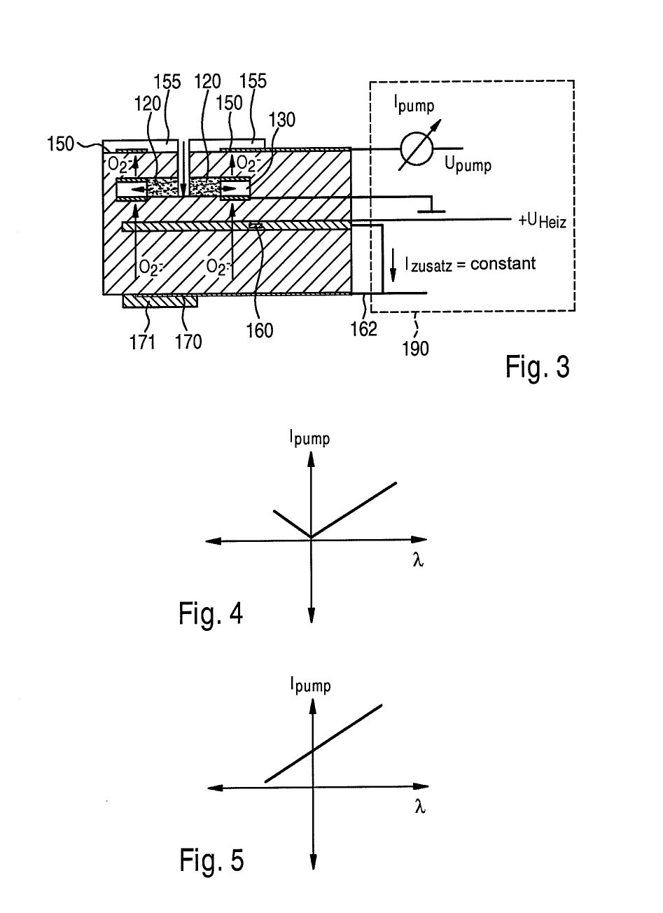

In order to imply the exhaust gas composition now in a first embodiment an additional outer electrode 170 that is exposed to the exhaust gas is arranged at the solid electrolyte 110, which builds the sensor element, on the solid electrolyte's side that is turned away from outer electrode 150. This additional outer electrode 170 works as an additional pump electrode, which enables to pump away oxygen from the exhaust gas to the inner electrode that is arranged in the measuring volume 130 (see FIGS. 2 & 3). This is shown in FIGS. 2 and 3 by the arrows that are tagged with O₂₋.

In the embodiment that is shown in FIG. 2 the additional outer or pump electrode 170 is assigned to its own signal line 172, which is connected to the circuit 190 in order to analyze the measuring signal of the additional outer electrode 170 in the circuit 190.

The embodiment that is shown in FIG. 3 distinguishes itself from the embodiment that is shown in FIG. 2 only insofar that the additional outer electrode 170 has not its own signal line. In fact it is electronically conducting connected with the radiator mass 162. The heater cycle is therefore set to a higher potential in order to save an additional line, quasi by a ‘virtual mass’ versus the pump cycle and is then, as shown in FIG. 3, connected with the radiator mass over a conducting path with the additional outer electrode 170. The DC-radiator coupling that is produced hereby is in this case the desired offset current.

The additional outer electrode 170 is impinged with a constant current I_{addition}=constant. This way a pumping away of the oxygen from the additional outer pump electrode 170 into the measuring volume 130 takes place. The additionally pumped away oxygen is now pumped away itself from the inner electrode 140 during the operation of the gas sensor, so that a defined too lean output signal accrues.

If the additional pump current I_{addition} is big enough, a positive pump current originates also at a rich exhaust gas. A clear relation between the value of the pump current Iₚᵤₘₚ and the exhaust gas composition from rich to lean is enabled this way.

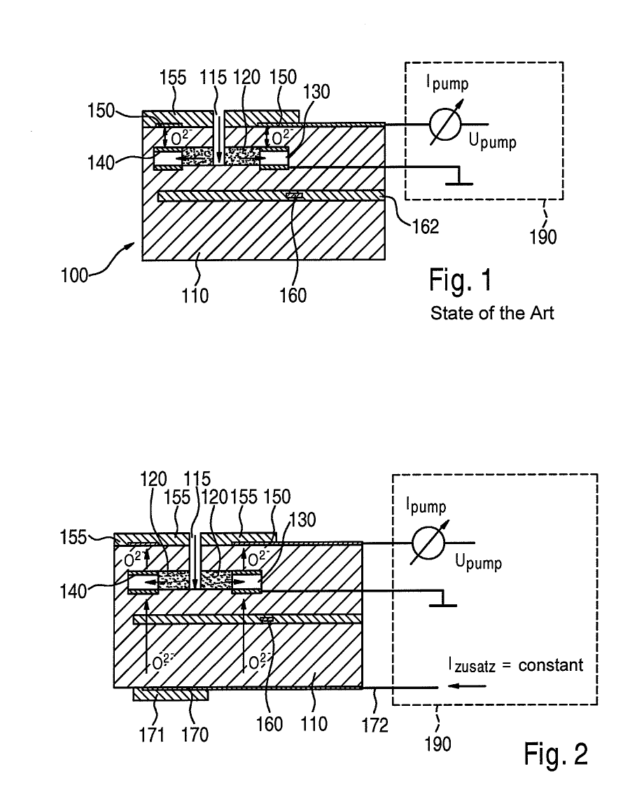

FIGS. 4 and 5 each show the pump current over the air value λ, whereby the current course in FIG. 4 corresponds with the one of the gas sensor shown in FIG. 1, while the pump current shown in FIG. 5 corresponds with the pump current of a gas sensor as it is shown in FIGS. 2 and 3. To make it more demonstrative one could term the arrangement of the additional outer electrode, which works as a pump electrode, also as offset pump. Unlike the gas sensor that is known from the state of the art, at which the pump current passes a change of direction (FIG. 4), the pump current Iₚᵤₘₚ of the gas sensor that is shown in FIGS. 2 and 3 runs only in the positive area, whereby a faster dynamic is enabled.

By arranging a protective layer 171 over the additional outer pump electrode 170 it is prevented that the additional outer electrode 170 experiences a gas change by the continuing pumping out of oxygen, whereby the so called λ=1-waviness is reduced.

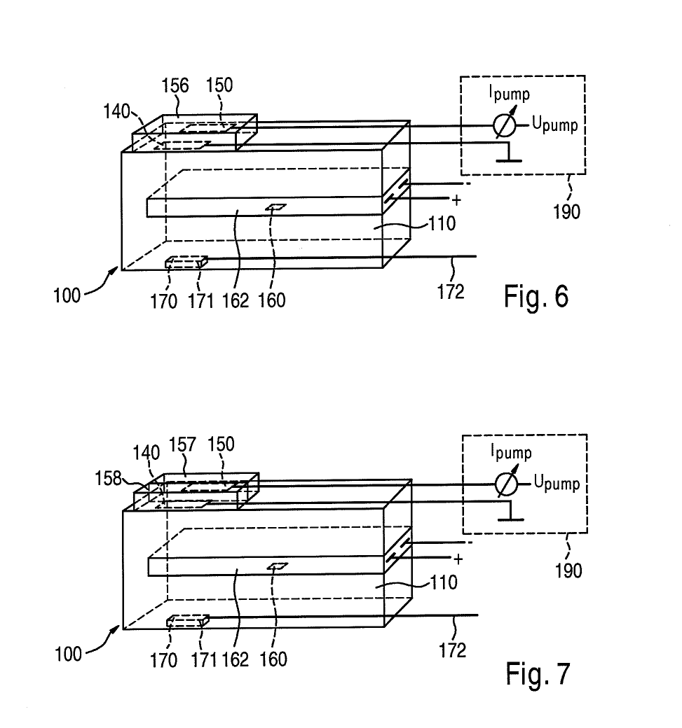

In a further embodiment of a gas sensor according to the invention as shown in FIG. 6 the second electrode 140 is not arranged in the measuring volume but like the first electrode 150 on the outside of the solid electrolyte 110. The first electrode 150 and the second electrode 140 are covered by a collective protective layer 156 and thereby separated from the exhaust gas.

Instead of a collective protective layer it can also be provided, as shown in FIG. 7, that the first electrode 150 and the second electrode 140 are each covered by a separate protective layer 157 and 158, which each can provide different characteristics for example regarding their porosity. The arrangement of the pump cell on the outside of the solid electrolyte 110 has especially great advantages regarding the manufacturing of such a gas sensor, since both outer electrodes can be produced in a single manufacturing procedure, for example by imprinting.

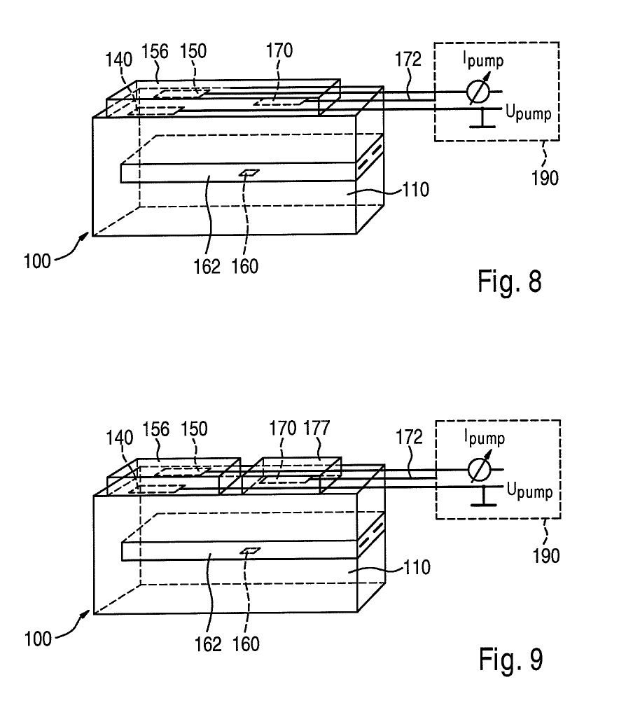

In the embodiment shown in FIGS. 8 and 9 the elements are labeled with the same references as they are in the embodiments shown in FIGS. 6 and 7, so that it is referred to it completely regarding their description.

But In the embodiment that is shown in FIGS. 8 and 9 the additional measuring electrode 170 is arranged on the same side as the first electrode 150 and the second electrode 140 and can therefore be produced very advantageously together with them in a single manufacturing process for example by imprinting.

In the embodiment that is shown in FIG. 8 the additional measuring electrode 170 is covered by the same protective layer 156 and so separated from the exhaust gas, which also covers the first electrode 150 and the second electrode 140.

In contrast to that the additional measuring electrode is covered by its own protective layer 177 and thereby separated from the exhaust gas in the embodiment that is shown in FIG. 9.

It shall be understood that in this embodiment (FIG. 9) the first electrode 150 and the second electrode 140 can be each covered by separated protective layers as it shown in FIG. 6. In this case all electrodes that are arranged on the outside of the sensor element, which means of the solid electrolyte 110, are each covered by its own protective layer.

1-12. (canceled)

13. A gas sensor, especially a lambda sensor, that determines an oxygen content in an exhaust gas of a combustion engine operated by a fuel-air mixture, the gas sensor comprising:
a pump cell formed with a sensor element, wherein the pump cell includes a first electrode and a second electrode, and wherein the first and second electrode are separated by at least one protective layer; and
an electronic circuit for the production of a voltage between the first electrode and the second electrode and for measurement and evaluation of a pump current in order to imply the composition of the fuel-air mixture;
wherein an additional outer electrode formed with the sensor element is exposed to the exhaust gas and impinged with a negative current.

14. A gas sensor according to claim 13, wherein the first electrode is arranged on a solid electrolyte that is formed with the sensor element and separated from the exhaust gas by at least one protective layer, and wherein the second electrode is positioned in a measuring volume that is formed in the solid electrolyte and separated from the exhaust gas by a diffusion barrier.

15. A gas sensor according to claim 13, wherein the first electrode and the second electrode are arranged on a solid electrolyte that is formed with the sensor element and are separated from the exhaust gas by at least one collective protective layer.

16. A gas sensor according to claim 13, wherein first electrode and the second electrode are arranged on a solid electrolyte that is formed with the sensor element and are separated from the exhaust gas by a plurality of separated protective layers.

17. A gas sensor according to claim 14, wherein the additional outer electrode is arranged on the solid electrolyte on a side that is opposite of the first electrode.

18. A gas sensor according to claim 13, wherein the additional outer electrode is covered by a protective layer.

19. A gas sensor according to claim 14, wherein the additional outer electrode is arranged on the solid electrolyte on a same side as the first electrode and the second electrode.

20. A gas sensor according to claim 19, wherein the additional outer electrode is separated from the exhaust gas by:
a. a protective layer that additionally covers the first electrode and the second electrode are also covered; or
b. a protective layer that does not cover the first electrode and the second electrode.

21. A gas sensor according to claim 13, wherein the negative current is of a constant magnitude.

22. A gas sensor according to claim 13, wherein the additional outer electrode is provided with a unique signal line.

23. A gas sensor according to claim 13, wherein the additional outer electrode is electrically-conducting connected to the ground connection of a heating device.

24. A gas sensor according to claim 13, wherein the electronic circuit is an engine control unit or a part of an engine control unit.
